(19) United States
(12) Patent Application Publication
(10) Pub. No.: US 2008/0046105 A1
(43) Pub. Date: Feb. 21, 2008

(54) METHOD FOR LOCATING INFORMATION AND SYSTEM USING THE SAME

(75) Inventors: Jf Yeh, Miaoli Hsien (TW); Yu-Cheng Hsieh, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/676,570

(22) Filed: Feb. 20, 2007

Related U.S. Application Data
(60) Provisional application No. 60/822,386, filed on Aug. 15, 2006.

(51) Int. Cl. G06F 17/30

(52) U.S. Cl. 700/94; 386/124

(57) ABSTRACT

A data processing system. A storage medium stores an audio data stream comprising a plurality of samples. A seek unit seeks through the audio data stream to determine a file offset of a target sample. A playback controller controls playback of the audio data stream. The playback controller is assigned an execution priority higher than the seek unit, and the seek unit and the playback controller operates according to their assigned execution priority.

### BACKGROUND

The invention relates to data processing, and in particular to a method of seeking a target position in a media stream and a system using the same.

This section is intended to introduce the reader to various aspects of the art, which may be related to various aspects of the invention, which are described and/or claimed below. This discussion is believed to be helpful in providing the reader with background information to facilitate a better understanding of the various aspects of the invention. Accordingly, it should be understood that these statements are to be read in this light, and not as admissions of related art.

For playback of media data, such as audio data (for example MP3 data) and video data (for example, MPEG4 data), one performance consideration is access time, also commonly referred to as seek time. Seek time is the time it takes to move from one data location to another data location in a storage medium.

Seek time varies according to size and format of a media file. For example, a seek procedure for a large media file or a media file using variable bit rate, consumes significant processor resources. Seek procedure and playback procedure are typically combined and assigned an execution priority higher than a user interface procedure. During the seek/playback procedure, the user interface procedure cannot make any interruption and the user interface will not respond to user input. Thus, some improvement is needed.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A data processing system is provided. A storage medium stores a media data stream comprising a plurality of samples. A seek unit seeks through the media data stream to determine a file offset of a target sample. A playback controller controls playback of the media data stream. The playback controller is assigned an execution priority higher than the seek unit, and the seek unit and the playback controller operate according to the assigned execution priority.

A data processing method for locating a target sample in a media data stream comprising a plurality of samples is also provided. A decoding time corresponding to the target sample is provided. A seek procedure, comprising seeking through the media data stream to determine the target sample file offset, is performed. A control procedure, comprising controlling playback of the target sample, is performed. The control procedure is assigned an execution priority higher than the seek procedure.

Also provided is a machine-readable storage medium comprising a computer program, which, when executed, directs a device to perform a data processing method for locating a target sample in a media data stream comprising a plurality of samples. A decoding time corresponding to the target sample is provided. A seek process, comprising seeking through the media data stream to determine the target sample file offset, is performed. A control procedure, comprising controlling playback of the target sample is performed. The control procedure is assigned an execution priority higher than the seek procedure.

### BRIEF DESCRIPTION OF DRAWINGS

The invention can be more fully understood by reading the subsequent detailed description and examples with references made to the accompanying drawings, wherein:

FIG. 1 illustrates a schematic view of an embodiment of a system capable of processing audio files; and

FIG. 2 is a flowchart of an embodiment of a method of locating a target sample in an audio data stream.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve developer specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

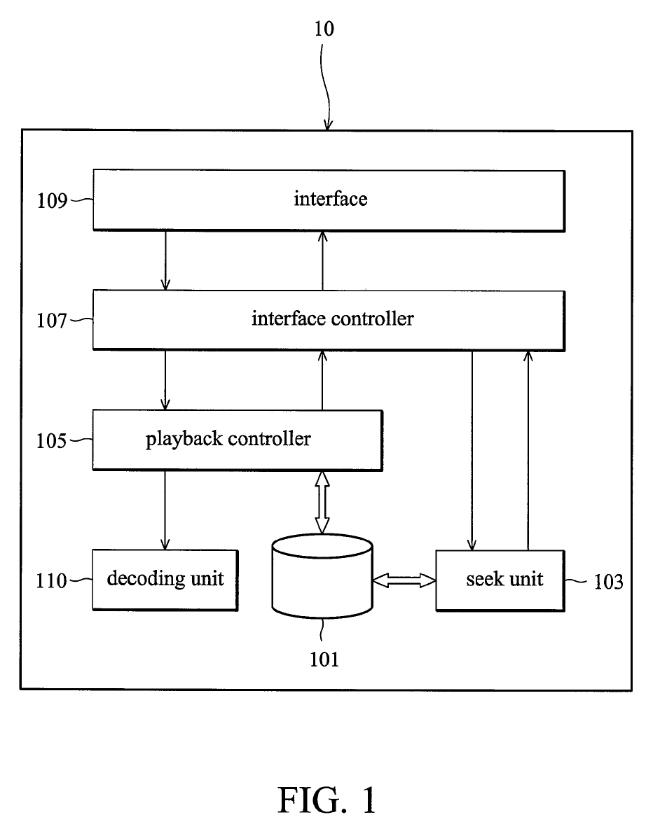

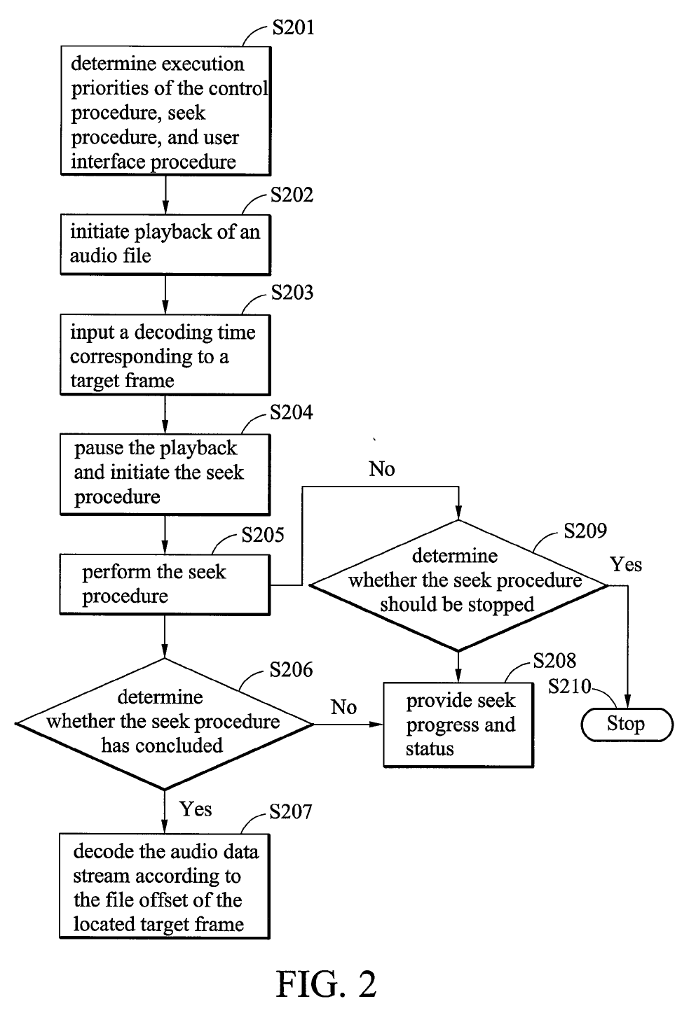

The invention is now described with reference to FIGS. 1 and 2. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures correspond to the Figure number, with the exception that the same reference number is used throughout to refer to an identical component which appears in multiple figures. It should be understood that many of the elements described and illustrated throughout the specification are functional in nature and may be embodied in one or more physical entities or may take other forms beyond those described or depicted.

FIG. 1 illustrates a schematic view of an embodiment of a system capable of processing media files. A system 10 comprises a storage medium 101, a seek unit 103, a playback controller 105, an interface controller 107, an interface 109, and a decoding unit 110.

The storage medium 101 stores a media data stream comprising a plurality of samples. Here, the media data stream can comprise an audio data stream and/or video data stream. For example, the media data stream can comprise a MP3 audio data stream, and the sample is a frame of the MP3 audio data stream. The audio data stream can also be another type of audio data not comprising metadata, such as audio data encoded in AAC (Advanced audio coding), or AMR/AWB format. For another example, the media data stream can comprise a video data stream, such as a MEPG 4 data stream.

The seek unit 103 seeks through the media data stream to determine a file offset of a target sample.

The playback controller 105 controls playback of the media data stream. The playback controller 105 is assigned an execution priority higher than the seek unit 103, and the seek unit 103 and the playback controller 105 operate according to the assigned execution priority. Here, the seek unit 103 and playback controller 105 operates separately according to the assigned execution priority. On the contrary, according to a conventional system, the functions realized by the seek unit 103 and playback controller 105 are performed by a single unit. In other words, according to a conventional system, the functions realized by the seek unit 103 and playback controller 105 are incorporated as a function of a single unit. In a conventional system, therefore, it is impossible to assign different execution priority to operation of the seek and playback function.

The interface 109 is used to receive and/or present information, wherein the interface 109 is controlled by the interface controller 107. The execution priority of the interface controller 107 falls between the playback controller 105 and the seek unit 103.

The seek unit 103, the playback controller 105, and interface controller 107 are assigned different execution priorities, respectively. The playback controller 105 is assigned the highest execution priority, the seek unit 103 is assigned the lowest execution priority, and the execution priority of interface controller 107 falls therebetween. The seek unit 103, playback controller 105, and interface controller 107 all operate according to their assigned execution priorities.

For example, because the execution priority of interface controller 107 is higher than seek unit 103, a user input requiring response of user interface can interrupt the operation of the seek unit 103 during a seek procedure. Moreover, because the execution priority of playback controller 105 is higher than interface controller 107, a playback process can not be interrupted by arbitrary operations of interface 109.

During a seek procedure, when interface 109 receives a user command and has to make some response, a user interface procedure for making the response has to be performed and therefore, the seek procedure has to be interrupted. Thus, the seek unit 103 shall halt the seek procedure accordingly.

The decoding unit 110 decodes the audio data stream according to the file offset of the located target sample.

Separate operation and differentiated execution priority of the priority of seek unit 103, playback controller 105, and interface controller 107 is a key point of the embodiment. Because when seek unit 103, playback controller 105, and interface controller 107 operate, a better operation efficiency can be obtained if the playback controller 105 has the highest execution priority, and the seek unit 103 has the lowest execution priority.

For example, when a user initiates the playback controller 105 to playback a media file. The media file comprises a media data stream comprising plurality of frames. The playback operation of the media file is divided into several parts, each of which is referred to as a playback sector. During the playback, user moves the playback forward by dragging a playback bar, presented on the interface 109, along a time length of the current file, and the decoding time corresponding to a target frame is determined accordingly. Here, because the playback controller 105 has an execution priority higher than the interface controller 107, the playback forward command cannot stop the playback control procedure immediately. The command received by interface 109 cannot be performed until the playback operation reaches an end of a playback sector. When the playback operation has reached the end of the playback sector, the playback operation pauses, and the seek unit 103 is initiated to determine in which playback sector the target frame is located.

When performing the seek operation, seek unit 103 can provide progress of the seek operation. The progress of seek operation can be presented via interface 109 to inform a user of the progress of seek operation. The progress of the seek procedure can be presented on the display via a time length bar. Information of the progress can be periodically provided by the seek unit 103 in an active way or passive way. According to the active way, the seek unit 103 periodically, say 0.5 seconds, reports the progress to the interface controller 107 to direct the interface 109 to display the progress information. The interface controller 107 directs the interface 109 to update and present the progress. According to the passive way, the interface controller 107 directs seek unit 103 to periodically query for the progress of the seek operation. The seek unit 103 pauses seeking and provides progress information to the interface controller 107 in response to receiving the query.

In addition, because the interface controller 107 has a higher priority than the seek unit 103, a user can interrupt operation of the seek unit 103 by inputting a user command via interface 109.

When the file offset of the target frame is determined, the seek procedure ends. The media data stream is then decoded according to the file offset of the located target frame, and the playback resumes from the located target frame.

FIG. 2 is a flowchart illustrating the steps of an embodiment of a method for locating a target sample in a media data stream. Here, the media data stream can comprise an audio data stream and/or video data stream. For example, an audio data stream can be decoded according to an MP3 (MPEG-1 Audio Layer 3) format, and a frame of the MP3 audio data stream is used as a sample thereof. The audio data stream can also be another type of audio data not comprising metadata, such as audio data encoded in AAC (Advanced audio coding), or AMR/AWB format. For another example, the media data stream can comprise a video data stream, such as a MEPG 4 data stream.

In step S201, execution priority of the control procedure, seek procedure, and user interface procedure are determined. The playback control procedure has the highest execution priority, and the seek procedure has the lowest execution priority. The described procedures operate according to the assigned execution priorities. When a user cause the control procedure, seek procedure, and user interface procedure to be performed, a better operation efficiency can be obtained if the playback control procedure has the highest execution priority, and the seek procedure has the lowest execution priority. The cooperation of described procedures is detailed below.

In step S202, playback of a media file is initiated. The media file comprises a media data stream comprising plurality of frames. The playback operation of the media file is divided into several parts, each of which is referred to as a playback sector. During the playback, a decoding time corresponding to a target frame is input (step S203). For example, a user moves the playback forward by dragging a playback bar along the time length of the current file, and the decoding time corresponding to a target frame is determined accordingly. In this case, because the playback controller has an execution priority higher than the user interface, the playback forward command cannot stop the playback control procedure immediately. The command received by user interface cannot be performed until the playback reaches an end of a playback sector. In step S204, when the playback has reached the end of the playback sector, the playback pauses, and the seek procedure is initiated to determine in which playback sector the target frame is located.

In step S205, the seek procedure is performed to seek through the media file to determine a file offset of the target frame. When the file offset of the target frame is determined, the seek procedure concludes. In step S206, it is determined whether the seek procedure has concluded, and if so, the method proceeds to step S207, and otherwise, proceeds to step S208.

In step S208, during the seek procedure, seek progress is provided by the seek unit 103. In step S209, it is determined whether the seek procedure should be stopped, and if so, the method proceeds to step S210, and otherwise, proceeds to step S205. The seek procedure can be stopped by a user command input via the user interface. Because the user interface has a higher priority than the seek unit, the user interface can stop the seek procedure when a user command is received. In addition, the user interface provides progress of the seek procedure on a display. The progress of the seek procedure can be presented on the display via a time length bar. Information of the progress can be periodically provided by the seek unit in an active way or passive way. In the active way, the seek unit periodically, say 0.5 seconds, reports the progress to the user interface. The user interface updates and presents the progress in a display. In the passive way, the user interface periodically pauses the seek procedure and query for the progress of the seek procedure. The seek unit pauses seeking and provides progress information to the user interface in response to the query.

In step S207, the media data stream is decoded according to the file offset of the located target frame, and the playback resumes from the located target frame.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A data processing method for locating a target sample in a media data stream comprising a plurality of samples, the method comprising:
providing a decoding time corresponding to the target sample;
performing a seek procedure to seek through the media data stream to determine a file offset of the target sample; and
performing a control procedure to control playback of the target sample, wherein the control procedure is assigned an execution priority higher than the seek procedure.

2. The method of claim 1, further performing a user interaction process to receive and/or present information, wherein the user interaction process is assigned the execution priority between the control procedure and the seek procedure.

3. The method of claim 2, further receiving a seek procedure interrupt command, and stopping the seek procedure accordingly.

4. The method of claim 2, after the seek procedure has concluded, further presenting the progress of the seek procedure.

5. The method of claim 2, further receiving a query for seek procedure progress, and providing the progress of the seek procedure in response.

6. The method of claim 1, further decoding the media data stream according to the file offset of the located target sample.

7. The method of claim 1, wherein the media data stream comprises an audio data stream.

8. The method of claim 7, wherein the audio data stream is decoded according to an MP3 (MPEG-1 Audio Layer 3), AAC (Advanced audio coding), or AMR/AWB format.

9. The method of claim 7, wherein the audio data stream is an MP3 audio data stream, and the sample is a frame thereof.

10. The method of claim 1, wherein the media data stream comprises a video data stream.

11. The method of claim 10, wherein the video data stream is a MEPG 4 data stream.

12. A data processing system, comprising:
a storage medium storing a media data stream comprising a plurality of samples;
a seek unit seeking through the media data stream to determine a file offset of a target sample; and
a playback controller controlling playback of the media data stream,
wherein the playback controller is assigned an execution priority higher than the seek unit, and the seek unit and the playback controller operate according to their assigned execution priority.

13. The system of claim 12, further comprising an interface controller to control an interface, wherein the assigned execution priority of the interface controller falls between the execution priority of the playback controller and the execution priority of the seek unit.

14. The system of claim 13, wherein the interface further receives a seek procedure interrupt command, and the seek unit halts the seek procedure accordingly.

15. The system of claim 13, wherein when the seek procedure executed by the seek unit has concluded, the seek unit sends a progress report to the interface controller, the interface controller directs the interface presents the report accordingly.

16. The system of claim 13, wherein the interface further receives a query for seek procedure progress, and provides the progress of the seek procedure in response.

17. The system of claim 12, further comprising a decoding unit, decoding the media data stream according to the file offset of the located target sample.

18. The system of claim 12, wherein the media data stream comprises an audio data stream.

19. The system of claim 18, wherein the audio data stream is encoded according to an MP3 (MPEG-1 Audio Layer 3), AAC (Advanced audio coding), or AMR/AWB format.

20. The system of claim 18, wherein the audio data stream is an MP3 audio data stream, and the sample is a frame thereof.

21. The system of claim 12, wherein the media data stream comprises a video data stream.

22. The method of claim 20, wherein the video data stream is a MEPG 4 data stream.
